(19) United States
(12) Patent Application Publication
(10) Pub. No.: US 2025/0307626 A1
(43) Pub. Date: Oct. 2, 2025

(54) SYSTEMS AND METHODS TO BUILD AUTOMATED BOTS USING GENERATIVE LEARNING

(71) Applicant: Infobip Ltd., London (GB)

(72) Inventors: Petra FRIBERT, Zagreb (HR); Emanuel LACIC, Zagreb (HR); Anamarija LUKAC, Zagreb (HR); Ivica LOVRIC, Zagreb (HR)

(73) Assignee: Infobip Ltd., London (GB)

(21) Appl. No.: 18/624,747

(22) Filed: Apr. 2, 2024

(51) Int. Cl. G06N 3/08

(52) U.S. Cl. CPC G06N 3/08

(57) ABSTRACT

A system may collect at least one initial chatbot dataset, and the system may clean the at least one initial chatbot dataset. The system may generate at least one processed dataset, wherein the at least one processed dataset is based on the at least one cleaned initial chatbot dataset. The system may provide the at least one processed dataset to a large language model and request a dataset property from the large language model, wherein the dataset property is based on a query submitted to the large language model. The system may receive the dataset property from the large language model provide, and the system may generating at least one enriched dataset incorporating the dataset property.

### TECHNICAL FIELD

Various aspects of the present disclosure relate generally to machine learning, generative learning, and large language models for bot and chatbot applications, and in particular, various aspects relate to machine learning and generative learning techniques for generating automated chatbots and for generating enriched chatbot datasets utilized in generating automated chatbots.

### BACKGROUND

Visual-based chatbot building platforms allow users to efficiently develop and deploy chatbot solutions, including design of conversation flows and interactions with consumer queries. Efficient, coherent, and accurate automated solutions are becoming particularly important in the context of managing multiple conversation flows, dialogs, topics, and functions across various subjects of consumer chatbot engagement and interactions.

Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for generating an automated chatbot training dataset, the method including: collecting, via a computer, at least one initial chatbot dataset; cleaning, via the computer, the at least one initial chatbot dataset; generating, via the computer, at least one processed dataset, wherein the at least one processed dataset is based on the at least one cleaned initial chatbot dataset; providing, via the computer, the at least one processed dataset to a large language model; requesting, via the computer, a dataset property from the large language model, wherein the dataset property is based on a query submitted to the large language model; receiving, via the computer, the dataset property from the large language model; and generating, via the computer, at least one enriched dataset incorporating the dataset property.

In some aspects, the techniques described herein relate to a method, wherein the initial chatbot dataset includes one or more of a bot dataset, an intent dataset, or a dialog dataset.

In some aspects, the techniques described herein relate to a method, wherein cleaning further includes identifying data types in the initial chatbot dataset for removal or alteration.

In some aspects, the techniques described herein relate to a method, wherein the large language model is a proprietary large language model.

In some aspects, the techniques described herein relate to a method, wherein the at least one enriched dataset includes a textual description of the processed dataset output by the large language model.

In some aspects, the techniques described herein relate to a method, wherein the textual description includes a short description and a long description.

In some aspects, the techniques described herein relate to a method, further including training, via the computer, a machine learning model using the enriched dataset.

In some aspects, the techniques described herein relate to a system for generating an automated chatbot training dataset, the system including: a non-transitory computer readable medium configured to store processor-readable instructions; and a processor operatively connected to the non-transitory computer readable medium, and configured to execute the instructions to perform operations including: collecting at least one initial chatbot dataset; cleaning the at least one initial chatbot dataset; generating at least one processed dataset, wherein the at least one processed dataset is based on the at least one cleaned initial chatbot dataset; providing the at least one processed dataset to a large language model; requesting a dataset property from the large language model, wherein the dataset property is based on a query submitted to the large language model; receiving the dataset property from the large language model; and generating at least one enriched dataset incorporating the dataset property.

In some aspects, the techniques described herein relate to a system, wherein the initial chatbot dataset includes one or more of a bot dataset, an intent dataset, or a dialog dataset.

In some aspects, the techniques described herein relate to a system, wherein cleaning further includes identifying data types in the initial chatbot dataset for removal or alteration.

In some aspects, the techniques described herein relate to a system, wherein the large language model is a proprietary large language model.

In some aspects, the techniques described herein relate to a system, wherein the at least one enriched dataset includes a textual description of the processed dataset output by the large language model.

In some aspects, the techniques described herein relate to a system, wherein the textual description includes a short description and a long description.

In some aspects, the techniques described herein relate to a system, wherein the operations further include training a machine learning model using the enriched dataset.

In some aspects, the techniques described herein relate to a non-transitory computer readable medium configured to store processor-readable instructions, wherein when executed by a processor, the instructions perform operations including: collecting at least one initial chatbot dataset; cleaning the at least one initial chatbot dataset; generating at least one processed dataset, wherein the at least one processed dataset is based on the at least one cleaned initial chatbot dataset; providing the at least one processed dataset to a large language model; requesting a dataset property from the large language model, wherein the dataset property is based on a query submitted to the large language model; receiving the dataset property from the large language model; and generating at least one enriched dataset incorporating the dataset property.

In some aspects, the techniques described herein relate to a non-transitory computer readable medium, wherein the initial chatbot dataset includes one or more of a bot dataset, an intent dataset, or a dialog dataset.

In some aspects, the techniques described herein relate to a non-transitory computer readable medium, wherein cleaning further includes identifying data types in the initial chatbot dataset for removal or alteration.

In some aspects, the techniques described herein relate to a non-transitory computer readable medium, wherein the large language model is a proprietary large language model.

In some aspects, the techniques described herein relate to a non-transitory computer readable medium, wherein the at least one enriched dataset includes a textual description of the processed dataset output by the large language model.

In some aspects, the techniques described herein relate to a non-transitory computer readable medium, further including training a machine learning model using the enriched dataset.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 is a block diagram of an exemplary automated chatbot generation and enriched chatbot dataset generation system, in accordance with an aspect.

FIG. 2 depicts an exemplary flow diagram for collecting, cleaning and processing an initial dataset to generate an enriched dataset, in accordance with an aspect.

FIG. 3 depicts an exemplary flow diagram for generating a trained machine learning model for generating chatbots and for generating chatbots based on user input, wherein the machine learning model is trained utilizing an enriched dataset and/or additional datasets, in accordance with an aspect.

FIG. 4A depicts an exemplary embodiment of a method of collecting, cleaning, and processing an initial dataset to generate an enriched dataset, in accordance with an aspect.

FIG. 4B depicts an exemplary embodiment of a method of collecting, cleaning, and processing an initial dataset to generate an enriched dataset, in accordance with an aspect.

FIG. 5 depicts an exemplary embodiment of a method of generating a trained machine learning model for generating chatbots, wherein the machine learning model is trained utilizing an enriched dataset and/or additional datasets, in accordance with an aspect.

FIG. 6 illustrates an exemplary image of an enriched dataset and a chatbot structure, in accordance with an aspect.

FIG. 7 illustrates an exemplary image of a chatbot generation interface, in accordance with an aspect.

FIG. 8 illustrates an exemplary image of a prompt interface utilized in chatbot generation, in accordance with an aspect.

FIG. 9 illustrates an exemplary image of a chatbot dialog interface generated according to a machine learning model, in accordance with an aspect.

FIG. 10 illustrates an exemplary image of a chatbot dialog editing/revising prompt interface, in accordance with an aspect.

FIG. 11 depicts a flow diagram for training a machine learning model, in accordance with an aspect.

FIG. 12 depicts an example of a computing device, in accordance with an aspect.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to techniques for machine learning and generative learning for automated chatbot generation and enriched chatbot dataset applications. For instance, certain aspects include utilizing large language models to generate enriched chatbot datasets based on existing chatbot datasets, wherein the enriched chatbot datasets may be utilized in training machine learning models to generate automated chatbot systems.

Technical advantages of the disclosed techniques include efficiently and adaptably generating enriched chatbot data and automated chatbots, including chatbot flows, dialogs, elements, and other data from user prompts.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated/correlated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistic regression, random forest, gradient boosted machine (GBM), graph neural networks (GNN), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning and large language models, it should be understood that techniques according to this disclosure may be adapted to any suitable type of machine learning and/or large language models. It should also be understood that the examples above are illustrative only. The techniques and technologies of this disclosure may be adapted to any suitable activity.

For example, one or more machine learning models may be utilized in connection with chatbot platforms. A chatbot platform may include a software-based program that is designed to automatically converse and interact with a user, locally and/or via a network. A chatbot may receive and process conversations, inputs, requests, etc. from a user and provide a response. A chatbot may interact with a user through textual language, spoken language, or other similar forms of interaction. A chatbot may be configured to implement a dialogue based on predetermined or dynamically determined criteria. A chatbot may access one or more databases to implement a dialogue with a consumer.

As discussed herein, one or more machine learning models may be trained to understand a chatbot datasets and enriched chatbot datasets, including a variety of dialogs, intents, bots, and underlying data elements/properties. Such machine learning models may be trained using chatbot datasets and enriched chatbot datasets (e.g., active bots, intents, dialogs, etc.). A machine learning model trained to understand chatbot datasets and enriched chatbot datasets may be trained to generate chatbots (e.g., chatbot flows, structures, etc.) and may be trained to edit/adjust one or more weights, layers, nodes, biases, synapses, flow elements, tasks, actions, and/or other chatbot elements based on the chatbot dataset and/or enriched chatbot dataset. A machine learning model may include components (e.g., weights, layers, nodes, biases, and/or synapses, etc.) that collectively associate underlying data in chatbot datasets and/or enriched chatbot datasets. A machine learning model may correlate this underlying data in a contextual landscape for use in generating chatbot flows based on prompts/input from consumers. A machine learning model may be trained to adjust one or more weights, layers, nodes, biases, and/or synapses to associate certain chatbot datasets and/or enriched chatbot datasets in view of a complete chatbot dataset/enriched chatbot dataset landscape. For example, certain underlying data may be automatically correlated with certain data descriptions to generate an enriched/trained dataset for use in building a chatbot based on consumer input/prompts. As another example, a large language model provider may utilize an initial chatbot dataset to generate an enriched chatbot dataset based on specified parameters/criteria. Further, for example, this enriched chatbot dataset may be used to train a machine learning model to generate and revise chatbot flows/elements based on consumer input/prompts and on end-user inputs/prompts.

An automated chatbot machine learning model may be trained using chatbot datasets, as discussed herein. Such data may include, for example, a bot dataset, an intent dataset, and/or a dialog dataset. For example, a bot dataset may include one or more identifiers such as account identifiers (Account IDs), Bot identifiers (Bot IDs), names, attribute information, and/or channel data. Similarly, for example, a cleaned bot dataset may include attributes and data such as a bot identifier, name, channel, clean name, bot attributes, test bot attributes, grouped phrases, grouped intent names, grouped content, and/or grouped dialog names and/or related data. For example, an intent dataset may include an ID, AccountID, BotID, InternalID, Name, and/or Phrases data. For example, a dialog dataset may include ID, AccountID, BotID, IntentID, Name, and/or Elements data. Similarly, for example, a cleaned dialog dataset may include ID, AccountID, BotID, IntentID, Name, Elements, Structure, ElementsList, and/or content data.

Similarly, an automated chatbot machine learning model may be trained on enriched bot datasets, including an enriched bot dataset and/or an enriched dialog dataset. For example, an enriched bot dataset may include one or more identifiers such as account identifiers (Account IDs), description data/attributes, Bot identifiers (Bot IDs), names, attribute information, and/or channel data. Similarly, for example, an enriched bot dataset may include attributes and data such as a bot identifier, name, channel, clean name, bot attributes, test bot attributes, grouped phrases, grouped intent names, grouped content, and/or grouped dialog names and/or related data. For example, an enriched bot dataset may include a bot identifier, a name, a channel, a clean name, one or more attributes, test bot attributes, grouped phrases, grouped intent names, grouped content, grouped dialog names, short description, long description, and/or related data. Similarly, for example, an enriched dialog dataset may include one or more identifiers (e.g., account identifiers, bot identifiers, intent identifiers, etc.), name, elements, structure, elements list, content, short description, long description, and/or related data.

As another example, a chatbot machine learning model may be trained by modifying one or more weights, layers, nodes, biases, and/or synapse to associate and/or correlate information among given datasets and their underlying data and/or with datasets/data generated using large language model providers.

According to aspects, one or more given chatbot and/or chatbot data learning model types (e.g., generative learning, linear regression, logistic regression, random forest, gradient boosted machine (GBM), deep learning, graph neural networks (GNN) and/or a deep neural network) may be determined based on attributes of a given chatbot and/or chatbot dataset for which the one or more machine learning models are applied. The attributes may include, for example, data contained within an enriched bot dataset and/or an enriched dialog dataset. Accordingly, a given learning model type may be determined based on analyzing the attributes of a given chatbot and/or chatbot dataset and comparing such attributes to known or dynamically determined properties of respective learning model types. According to an implementation, a model score may be determined for a plurality of model times based on each model types applicability to a given chatbot and/or chatbot dataset. A model with the highest score or a score that meets a model score threshold may be selected.

According to aspects, a chatbot machine learning model may receive inputs including data for a given dataset and may generate a matrix representation based on features of the given dataset. The chatbot machine learning model may be trained to determine potential features for the given chatbot and/or dataset. For example, the matrix may include fields and/or sub-fields related to an enriched bot dataset, an enriched dialog dataset, etc. Attributes related to each field or sub-field may be populated within the matrix, based on received or extracted data. The chatbot machine learning model may perform operations based on the generated matrix. The features may be updated based on input data (from users and/or end consumers) or updated training data based on, for example, chatbot data associated with features that the model is not previously trained to associate with a given dataset and/or the underlying data. Accordingly, chatbot machine learning models may be iteratively trained based on chatbot data or simulated data.

While chatbots and various aspects relating to chatbots (e.g., web-based, application-based, software-based, SMS-based, chat-based) are described in the present aspects as illustrative examples, the present aspects are not limited to such examples. For example, the present aspects can be implemented for other consumer facing systems or products, such as automated voice/telephonic chatbots, in-person chatbots (e.g., self-service kiosks, etc.), etc.

Systems and techniques disclosed herein are directed to utilizing large language models for efficient and accurate automated generation of enriched chatbot datasets. These systems and techniques allow for a rich dataset that may be utilized in training a machine learning model for generating automated chatbots, including designing of conversation flows, elements, functions, and interactions in response to end-user queries and input, including textual input.

Some approaches for generating visual-based chatbot building permit consumers/users to develop chatbots (e.g., flows, conversations, interactions, etc.) using, for example, code-based and/or drag-and-drop interfaces. Such approaches rely on consumer decision-making, where consumers may not be well-versed or efficient in creating such chatbot solutions.

According to systems and techniques disclosed herein, an automated chatbot may be generated based on prompts and/or input (e.g., textual instructions) from a consumer, wherein the consumer may input the desired chatbot solution/functionality and/or elements, and a system environment generates and/or revises a chatbot solution utilizing machine learning techniques trained on, for example, an enriched chatbot dataset. Such chatbot generation may include, for example, creation of chatbot flows, automations, copywriting, decision branches, and similar functionality, including for example, the code underlying such functionalities.

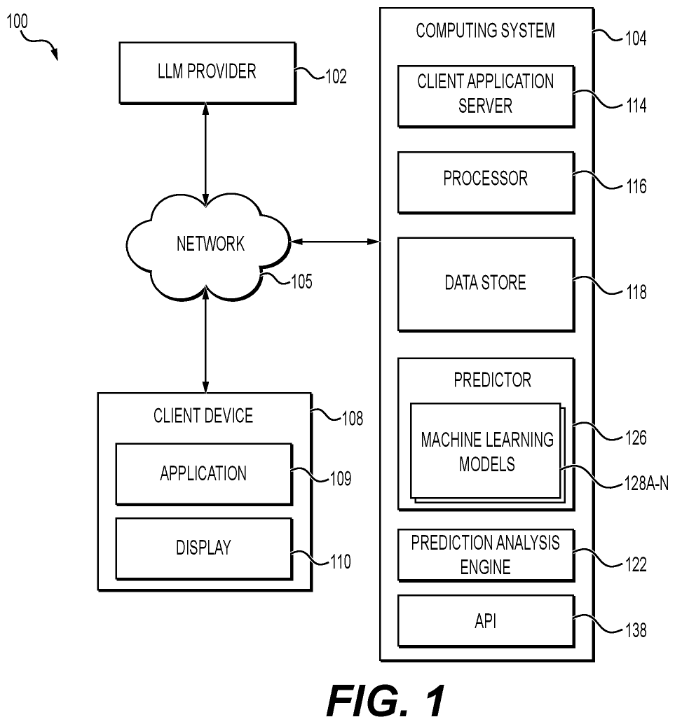

FIG. 1 is a block diagram illustrating a tracking and analytics environment 100, according to example aspects. Environment 100 includes LLM provider (e.g., large language model provider) 102, computing system 104, and client device 108 connected via network 105. In the example depicted, LLM provider 102 receives clean chatbot datasets and/or raw chatbot datasets and generates enriched datasets based on certain specifications and/or criteria. In an example, LLM provider 102 may receive a cleaned chatbot dataset from computing system 104, wherein LLM provider 102 may generate an enriched dataset based on parameters/criteria provided to the LLM provider 102. Computing system 104 may utilize the enriched dataset for purposes of training predictor 126 (including machine learning models 128A-N) in conjunction with prediction analysis engine 122 to, in turn, generate automated chatbots based on prompts/input from client device 108.

In some aspects, LLM provider 102 may be a large language learning model provider or may be a proprietary large language or other machine/generative learning model. While one LLM provider 102 is depicted, additional LLM providers 102 are possible. For example, a system of multiple LLM providers 102 may be utilized for comparison purposes in selecting an appropriate LLM provider 102 based on accuracy, efficiency, and desired output of an enriched dataset. Similarly, such LLM providers may be further tuned for accuracy, efficiency, hallucinations (e.g., a response containing false, misleading, incoherent, etc. data).

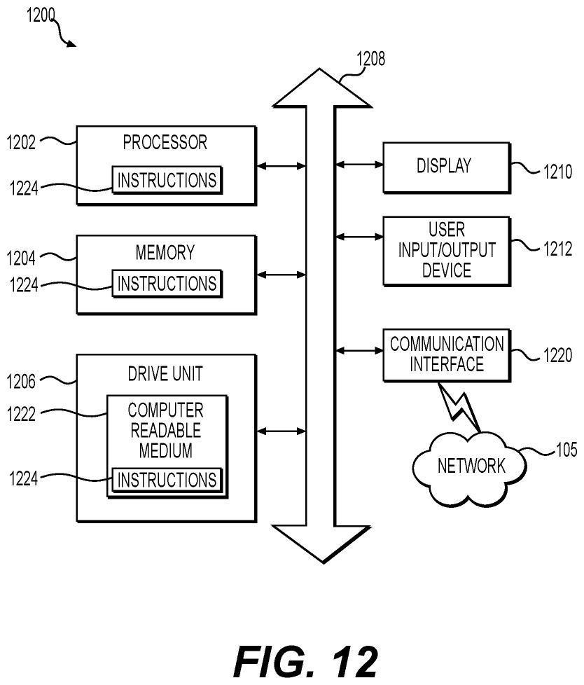

LLM provider 102 may be configured to communicate with computing system 104 via network 105. Computing system 104 may be configured to manage and analyze the chatbot datasets provided to the LLM provider 102 as well as the data (e.g., enriched dataset) output by LLM provider 102. Computing system 104 may include a web client application server 114, a pre-processing agent 116, a data store 118, and a third-party Application Programming Interface (API) 138. An example of computing system 104 is depicted with respect to FIG. 12.

Pre-processing agent 116 may be configured to process data retrieved from data store 118 and/or LLM provider 102 prior to input to predictor 126.

Data store 118 may be configured to store different kinds of data. In an example, data store 118 can store chatbot datasets (e.g., initial datasets) and cleaned chatbot datasets, as well as enriched dataset or other data received from LLM provider 102.

Predictor 126 includes one or more machine-learning models 128A-N. For example, predictor 126 may utilize one or more trained models and/or trained datasets to predict and generate a chatbot (e.g., chatbot flows, functions, components, etc.) based on prompts/input from a consumer via client device 108. Predictor 126 may thus accurately and efficiently identify the appropriate chatbot structure (e.g., chatbot flows, functions, components, copywriting, decision trees, etc.) to achieve the consumer's desired objectives where, for example, an end-user may define the objectives via textual input. Similarly, predictor 126 may accurately identify changes to an existing chatbot structure to achieve a consumer's desired revisions to the existing chatbot, where for example, a user may input desired revisions via textual input.

Client device 108 may be in communication with computing system 104 via network 105. Client device 108 may be operated by a consumer. For example, client device 108 may be a mobile device, a tablet, a desktop computer, or any computing system having the capabilities described herein. Consumers may include, but are not limited to, individuals such as, for example, operators, subscribers, clients, prospective clients, or customers of an entity associated with computing system 104, such as individuals who have obtained, will obtain, or may obtain a product, service, or consultation from an entity associated with computing system 104. Such consumers may access computing system 104 for purposes of generating a chatbot to be used interactively with the consumer's end-users (e.g., the consumer's customers). Similarly, an end-user may be generally be a member of the public who interacts with a chatbot through a client device 108 via a network 105.

Client device 108 may include one more applications 109. Application 109 may be representative of a web browser that allows access to a website or a stand-alone application. Client device 108 may access application 109 to access one or more functionalities of computing system 104. Client device 108 may communicate over network 105 to request a webpage, for example, from web client application server 114 of computing system 104. For example, client device 108 may be configured to execute application 109 to access content managed by web client application server 114. The content that is displayed to client device 108 may be transmitted from web client application server 114 to client device 108, and subsequently processed by application 109 for display through a graphical user interface (GUI) of client device 108.

Client device may include display 110. Examples of display 110 include, but are not limited to, computer displays, Light Emitting Diode (LED) displays, and so forth. Output or visualizations generated by application 109 can be displayed on display 110.

Functionality of sub-components illustrated within computing system 104 can be implemented in hardware, software, or some combination thereof. For example, software components may be collections of code or instructions stored on a media such as a non-transitory computer-readable medium (e.g., memory of computing system 104) that represent a series of machine instructions (e.g., program code) that implements one or more method operations. Such machine instructions may be the actual computer code the processor of computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

Network 105 may be of any suitable type, including individual connections via the Internet, such as cellular or Wi-Fi networks. In some aspects, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

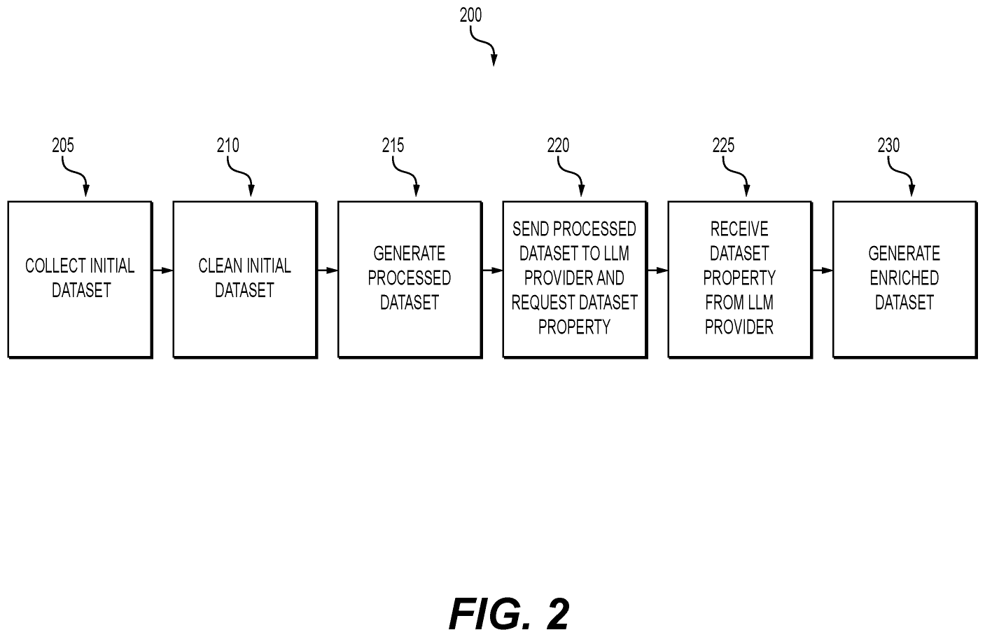

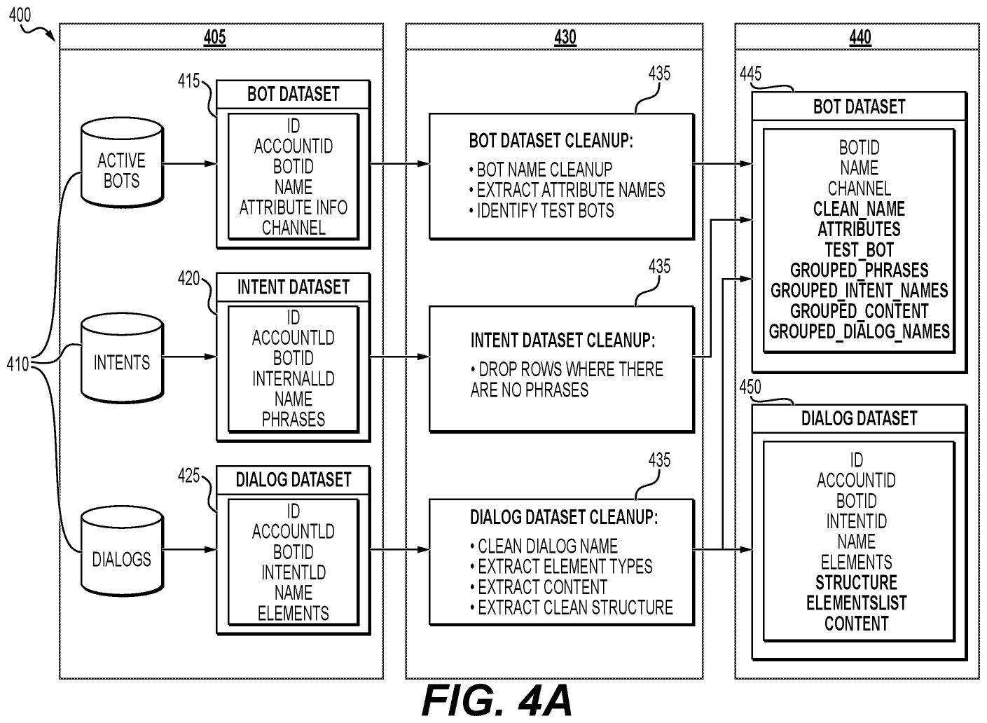

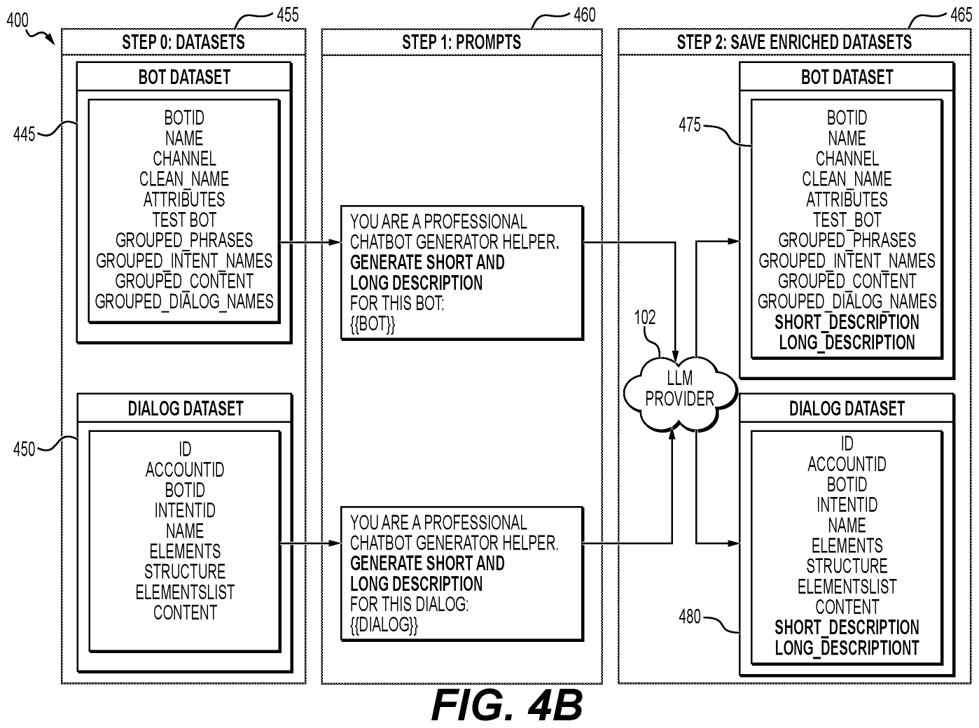

Referring now to FIG. 2, an exemplary flow diagram 200 is shown for collecting, cleaning and processing an initial dataset to generate an enriched dataset, in accordance with an aspect. As shown in flow diagram 200 of FIG. 2, at step 205, an initial dataset is collected, wherein the initial dataset is associated with at least one chatbot. For example, and as shown in FIG. 4A, the initial dataset may include a bot dataset, an intent dataset, and/or a dialog dataset.

According to one embodiment, for example, the bot dataset may contain data and information concerning specific chatbots that are in active usage with consumers and for which data has been associated/correlated. For example, a bot dataset may include one or more identifiers such as account identifiers (Account IDs), Bot identifiers (Bot IDs), internal identifiers (InternalID), names, attribute information, phrase information, and/or channel data. For example, the bot dataset may include: ID, AccountID, BotID, Name, AttributeInfo, Channel, etc. The intent dataset may contain sample data and information concerning end-user intent, where for example, a chatbot end-user may send a textual message to a chatbot and the chatbot, in turn, may classify the textual message into one or more topics of intent. For example, if an end-user were to send a message to the chatbot indicating that the end-user would like to purchase a ticket to an event, the message would be linked to a topic related to ticket purchases, wherein the chatbot may engage a certain chat flow relevant to the specific topic. For example, the intent dataset may include ID, AccountID, BotID, InternalID, Name, Phrases, etc. data/information.

According to one embodiment, for example, the dialog dataset may include sample dialogs that are linked to a specific intent where, for example, dialogs may comprise sequential and/or branching chatbot flows. For example, a dialog may create a network of possible options for chatbot flow depending on textual input from an end-user in communication with the chatbot. For example, a dialog dataset may include one or more identifiers such as account identifiers (Account IDs), Bot identifiers (BotIDs) intent identifiers (IntentIDs), name identifiers, element identifiers, and/or other similar identifiers. The dialog dataset may include ID, AccountID, BotID, IntentID, Name, Elements, etc.

At step 210, the initial dataset may be cleaned prior to being processed and transmitted to an LLM provider. For example, where the initial dataset is collected from active chatbot environments, it may be necessary to remove any confidential and/or personally-identifiable information entered by users when engaged with the chatbot (e.g., dialog elements containing textual messages with personally-identifiable information). In such an instance, a dialog element may not contain any information where such data has been removed as part of step 210. Alternatively, for example, a private and/or proprietary (e.g., internal) LLM may be utilized, wherein there is no risk that confidential and/or personally-identifiable information would be shared with a third-party LLM provider. In such an instance, removing/cleaning confidential and/or personally-identifiable information may not be necessary.

Similarly, for the Bot dataset, it may be necessary to clean the bot name, extract attribute names, and/or identify test bots from the chatbot environment. For the intent dataset, it may be necessary to remove data rows/entries where there are no phrases included. For the dialog dataset, it may be necessary to clean the dialog name, extract element types, extract content, and extract a clean data structure. For example, the computing system 104 may automatically identify certain data types included in the initial dataset and remove or alter data/information associated with the certain data types. Similarly, for example, a cleaning machine learning model may be utilized to identify certain data types for removal and/or altering, where the cleaning machine learning model may be trained using historical or simulated initial datasets and corresponding cleaned datasets to learn the data types to be identified for cleaning.

It will be appreciated by one of ordinary skill in the art that depending on the status and/or pre-processing of the initial dataset, step 210 may vary or may be unnecessary in exemplary flow diagram 200. For example, if the initial dataset does not contain personal/confidential data or is preformatted for transmission to the LLM provider, minimal or no cleaning may be required.

Referring now to step 215, a processed dataset may be generated in preparation for transmitting the dataset to an LLM provider. As part of generating the processed dataset, additional data fields may be added to those contained in the initial dataset. For example, a processed dataset for a bot dataset may include cleaned data from the initial bot dataset, intent dataset, and/or dialog datasets. For example, a processed bot dataset may include attributes, identifiers, and data such as a bot identifier, name, channel, clean name, dialog attributes, test bot data, grouped phrases data, grouped intent names, grouped content, grouped dialog names, and/or other bot datasets. The processed bot dataset may include data for BotID, Name, Channel, clean_name, attributes, test_bot, grouped_phrases, grouped_intent_names, grouped_content, grouped_dialog_names, and/or other data.

Similarly, a processed dialog dataset may include cleaned data from the initial dialog dataset, and the dialog dataset may include one or more identifiers, attributes, and/or data, including account identifiers, bot identifiers, intent identifiers, names, elements, structures element lists, content, and/or other datasets. For example, the dialog dataset may include data for ID, AccountID, BotID, IntentID, Name, Elements, Structure, ElementsList, Content, and/or other data.

Referring now to step 220, one or more processed datasets are sent to at least one LLM provider, wherein a prompt is sent to the LLM provider with instructions for generating an enriched dataset according to a desired output property, for example, a short and/or long description of an enriched dataset. As one non-limiting example, a processed bot dataset is transmitted to the LLM provider, wherein the LLM provider is instructed: “You are a professional chatbot generator helper. Generate short and long description for this bot: [Name of Bot].” As one non-limiting example, a processed dialog dataset is transmitted to the LLM provider, wherein the LLM provider is instructed: “You are a professional chatbot generator helper. Generate short and long description for this dialog: [Name of Dialog].”

These instructions may be fine-tuned across enriched dataset outputs to optimize for accuracy, efficiency, and desired outcome, wherein the instructions may be iteratively changed until sufficient accuracy, efficiency, and desired outcome are achieved.

Referring now to step 225, the output dataset property is received from the LLM provider, wherein the output dataset property may be based on the instructions provided to LLM provider in step 220.

Referring now to step 230, an enriched dataset is generated, wherein the enriched dataset may include the output dataset properties received from the LLM provider in step 225. These output dataset properties are generated based on the processed data transmitted to the LLM provider considering the instructions transmitted to the LLM provider concerning the desired output data properties.

It will be appreciated by one of ordinary skill in the art that the enriched dataset may be generated and received directly from the LLM provider.

As one non-limiting example, the enriched bot dataset may include synthetically generated properties (e.g., description properties) that describe a dataset (e.g., a processed dataset). For example, the additional properties of “short_description” and “long_description” where the LLM provider was instructed: “You are a professional chatbot generator helper. Generate short and long description for this bot: [Name of Bot].” Similarly, the enriched dialog dataset may include the additional properties of “short_description” and “long_description” where the LLM provider was instructed: “You are a professional chatbot generator helper. Generate short and long descriptions for this dialog: [Name of Dialog].”

Similarly, as additional non-limiting examples, the enriched bot dataset may include the following enriched properties for chatbots and/or dialogs: use cases (e.g., a use case of problem, context, or issue being addressed/solved); topics (e.g., topics of conversation and/or dialog between, for example, an end-consumer and a chatbot); industry information (e.g., industry-specific information and/or context for the industry in which the chatbot is being utilized); feedback on generated chatbots and/or dialogs (e.g., positive, negative, neutral). It will be appreciated by one of ordinary skill in the art that additional enriched properties may be utilized according to specific industry, content, technology, contexts and usages.

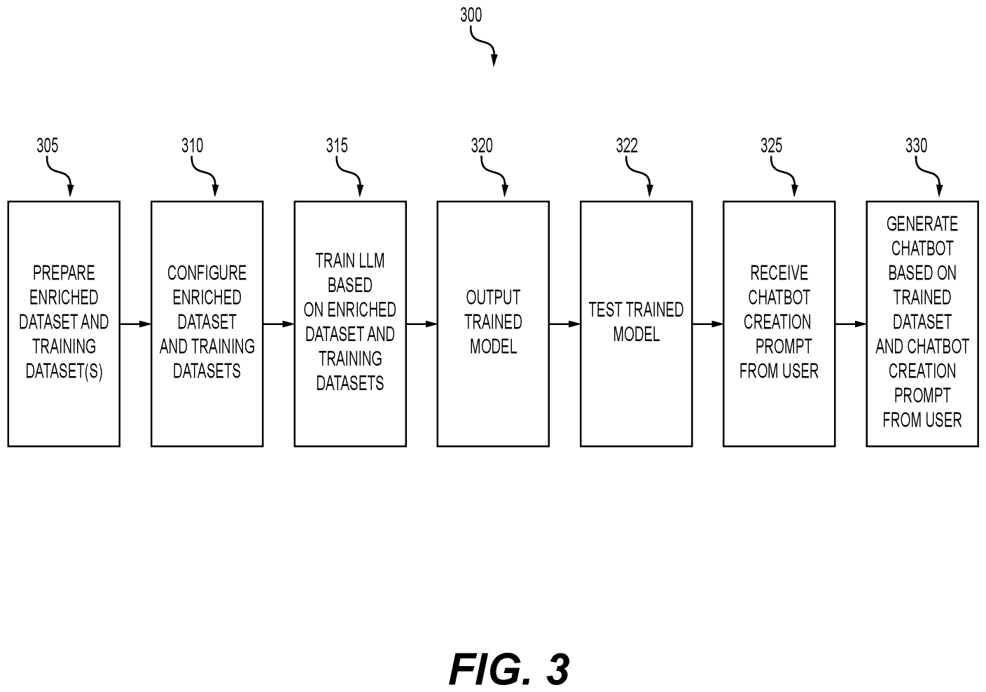

Referring now to FIG. 3, an exemplary flow diagram 300 is shown for generating a trained machine learning model for generating chatbots, wherein the machine learning model is trained utilizing an enriched dataset and/or additional datasets, in accordance with an aspect. As shown in flow diagram 300 of FIG. 3, at step 305, an enriched dataset(s) and/or training dataset(s) are prepared for training a machine learning model. As one non-limiting example, an enriched dataset may be used to create a training dataset, a validation dataset, and/or a test dataset to be utilized in training a machine learning model for generating chatbots. The enriched dataset may, for example, be an enriched dataset generated in step 230 of the exemplary flow diagram 200 of FIG. 2.

At step 310, the enriched dataset and/or training dataset may be configured to a format necessary for the machine learning model. It will be appreciated by one of ordinary skill in the art that step 310 may vary or may be unnecessary where an enriched dataset and/or training dataset has been previously configured/processed in a format suitable for the machine learning application.

At step 315, a machine learning model (e.g., an LLM) may be trained on the enriched dataset and/or training datasets. For example, machine learning techniques may be utilized to train a model on historical or active chatbots and underlying data, including for example, interactions between an end-user and the chatbot, chat flows, elements, dialogs, topics, functions, etc. across various subjects of consumer chatbot engagement and interactions. A machine learning model may receive, as an input, an enriched dataset and/or training dataset, wherein the enriched dataset and/or training dataset may be compared to, for example, historical bot data feeds to assess correlation of certain data objects (e.g., textual descriptions, dialog interactions between end-users and a bot, chat flows, elements, dialogs, topics, functions, etc.). As one non-limiting example, a trained model may be trained utilizing a validation dataset and/or a test dataset for assessing certain threshold levels of confidence to determine whether predictions are accurate and are to be utilized in automated chatbot generation.

The LLM may be trained to automatically generate a chatbot or a portion of chatbot. The training may include modifying one or more weights, layers, biases, synapsis, and/or the like based on training data that includes enriched data sets, training data sets, historical or simulated chatbots, and/or the like. The training may include learning associations between the training data and one or more historical or simulated chatbots that may correspond to the training data. Accordingly, the machine learning model may be trained to receive a production data set (e.g., a production enriched data set) and/or a prompt and may generate a production chatbot or a portion thereof based on the production data set and/or prompt.

At step 320, the trained model may be output for real-time integration with a chatbot generation platform. At step 325, a chatbot generation platform may receive a prompt from a consumer with instructions for creating a chatbot (e.g., a chatbot dialog), or additionally/alternatively, the chatbot generation platform may receive a prompt from a consumer with instructions for revising an existing chatbot (e.g., a chatbot dialog).

At step 322, the trained model may be tested for the quality and accuracy of the model using simulated and/or real chatbot and dialog data. The testing results may be utilized to iteratively improve the prior steps of training a model, including revisions to steps 305, 310, 315, and 320. Testing results may also be utilized to iteratively improve the prior steps of generating an enriched dataset, including steps 205, 210, 215, 220, 225, and/or 230 of FIG. 2. For example, the testing results may be utilized to determine the datasets and underlying data properties that are utilized to generate the enriched dataset. It will be appreciated that additional testing steps may occur at one or more steps prior to or following step 322 of FIG. 3, wherein testing may include comparison of datasets and/or trained models against simulated or real datasets to determine correspondence between datasets as well as quality and accuracy of data output from a trained model.

At step 330, a chatbot (e.g., a chatbot dialog) is generated based on the trained dataset and based on the prompt from a consumer. For example, based on the prompt from a consumer, the chatbot may be generated in reference to the context and objectives contained in the prompt, wherein such context and objectives may be assessed considering the trained machine learning model. For example, machine learning techniques may be utilized to process the consumer prompt for dialog, intent, description, and/or other data to generate a chatbot correlating with historical data related to the processed dialog, intent, description, and/or other data to accurately and efficiently generate a chatbot responsive to the consumer's prompt.

Following generation of a chatbot or a chatbot portion, a consumer may provide additional prompt instructions for revising an existing chatbot. Any changes may be provided to the machine learning model, wherein the machine learning model may be re-trained based on the changes to the existing chatbot. Subsequent chatbot generation may be based on the re-training and/or changes made by the user in revising the existing chatbot.

Referring now to FIGS. 4A-4B, an exemplary embodiment 400 of a method of collecting, cleaning and processing an initial dataset to generate an enriched datasets is shown, in accordance with an aspect. As shown in embodiment 400 of FIGS. 4A-4B, at step 405 data is collected from active bot assets 410 (e.g., bots, intents, and dialogs), including collected data associated with and input by end-users interacting with the bots, intents, and dialogs, including data captured continuously and/or over a time-period (e.g., .json config). It will be appreciated that the data may additionally or alternatively be collected from historically-used (e.g., non-active) or test bots.

A bot dataset 415 may be collected from an active bot and may include a variety of data properties/types and identifiers, including account identifiers, bot identifiers, names, attribute information, channel data, and/or other datasets. For example, a bot dataset may include ID, AccountID, BotID, Name, AttributeInfo, Channel, etc.

An intent dataset 420 may be collected from active intents, wherein the intent dataset may include categories/classes of data based on, for example, the types of intent that may be detected based upon an end-user's interaction with a chatbot. As one non-limiting example, where an end-user provides a textual input to a bot, indicating that the end-user would like to purchase tickets to an event, the bot may classify the intent as being associated/correlated with an intent category/class relevant to purchase of event tickets. For example, an intent dataset 420 may include one or more identifiers and/or other datasets, including account identifier, bot identifier, internal identifier, names, phrases, and/or other datasets. For example, the intent dataset 420 may include, for example, ID, AccountID, BotID, InternalID, Name, Phrases, etc.

A dialog dataset 425 may be collected from active dialogs, wherein the dialog dataset may include bot dialogs utilized in interaction with an end-user engaged with a chatbot and for which data has been associated/correlated, including data input from end-users interacting with the bot. According to one embodiment, for example, the dialog dataset 425 may include sample dialogs that are linked to a specific intent where, for example, dialogs may comprise sequential and/or branching chatbot flows. For example, a dialog may create a network of possible options for chatbot flow depending on textual input from an end-user in communication with the chatbot. As one non-limiting example, the dialog dataset 425 may include the underlying copywriting, chat dialog, flows, structure, decision trees, branched flows, properties, elements, actions, and other bot elements/properties. Such data may include, for example, one or more identifiers and/or other datasets, including account identifiers, bot identifiers, intent identifiers, names, elements, and/or other datasets. The dialog dataset 420 may include for example, ID, AccountID, BotID, IntentID, Name, Elements, etc.

At step 430, the initial datasets of bot dataset 415, intent dataset 420, and dialog dataset 425 may be cleaned prior to being processed and transmitted to an LLM provider. For example, where the initial datasets of bot dataset 415, intent dataset 420, and dialog dataset 425 is collected from active chatbot environments, it may be necessary to remove any confidential and/or personally-identifiable information entered by users when the user is engaged with the bot (e.g., dialog elements containing textual messages with personally-identifiable information). In such an instance, a dialog element may not contain any information where such data has been removed as part of step 210. Alternatively, for example, a private and/or proprietary (e.g., internal) LLM may be utilized, wherein there is no risk that confidential and/or personally-identifiable information would be shared with a third-party LLM provider. In such an instance, removing/cleaning confidential and/or personally-identifiable information may not be necessary.

Similarly, it may be necessary to engage in specific cleaning steps 435, which may include bot name cleanup, extracting attribute names, identifying test bots, removing rows/entries missing phrases/data, cleaning dialog names, extracting element names, extracting element types, extracting content, extracting clean structure, etc. It will be appreciated by one of ordinary skill in the art that depending on the status and/or pre-processing of the initial datasets of initial bot dataset 415, initial intent dataset 420, initial dialog dataset 425, etc., step 430 may vary or may be unnecessary in exemplary embodiment 400. For example, if an initial dataset does not contain person/confidential data or is preformatted for transmission to the LLM provider, minimal or no cleaning may be required.

Referring now to step 440, one or more processed datasets may be generated in preparation for transmitting the dataset to an LLM provider. As part of the generation of processed datasets, additional data fields may be added to those contained in the initial dataset. For example, a processed bot dataset 445 generated from an initial bot dataset 415 may include cleaned data from the initial bot dataset 415, initial intent dataset 420, and/or initial dialog dataset 425. For example, a processed bot dataset 445 may include one or more identifiers and/or other datasets, including bot identifiers, names, channel data, clean names, attributes, test bots, grouped phrases, grouped intent names, grouped dialog names, and/or other datasets. For example, the processed bot dataset 445 may include data for BotID, Name, Channel, clean_name, attributes, test_bot, grouped_phrases, grouped_intent_names, grouped_content, grouped_dialog_names, and/or other data. Similarly, a processed dialog dataset 450 may include cleaned data from the initial dialog dataset 425, and may include, for example, one or more identifiers, attributes, and/or other data, including account identifiers, bot identifiers, intent identifiers, names, elements, structures, elements lists, contents, and/or other datasets. For example, the processed dialog dataset 450 may include data for ID, AccountID, BotID, IntentID, Name, Elements, Structure, ElementsList, Content, and/or other data.

Referring now to FIG. 4B, at step 455, a processed bot dataset 445 and a processed dialog dataset 450 are sent to an LLM provider 102, wherein at step 460 a prompt is sent to the LLM provider 102 with instructions for generating an enriched dataset according to a desired output property. For example, the processed bot dataset is sent to the LLM provider 102, wherein the LLM provider is instructed: “You are a professional chatbot generator helper. Generate short and long descriptions for this bot: [Name of Bot].” Similarly, for example, the processed dialog dataset 450 is transmitted to the LLM provider 102, wherein the LLM provider 102 is instructed: “You are a professional chatbot generator helper. Generate short and long description for this dialog: [Name of Dialog].”

These instructions/prompts may be fine-tuned across enriched dataset outputs to optimize for accuracy, efficiency, and desired outcome, wherein the instructions may be iteratively revised until sufficient accuracy, efficiency, and desired outcome are achieved.

Referring now to step 465, the prompt, including for example, an output dataset property is received by the LLM provider 102, wherein it may be based on instructions/prompt provided to LLM provider 102. An enriched bot dataset 475 and an enriched dialog dataset 480 are generated, wherein the enriched bot dataset 475 and the enriched dialog dataset 480 may include the output dataset properties received from the LLM provider 102. The output dataset properties are generated based on the processed data transmitted to the LLM provider 102 considering the instructions/prompts transmitted to the LLM provider 102 concerning the desired output data properties. It will be appreciated by one of ordinary skill in the art that the enriched dataset may be generated and received directly from the LLM provider 102.

The enriched bot dataset 475 and the enriched dialog dataset 480 may include additional synthetically generated properties (e.g., description properties) that may describe a dataset. For example, the enriched bot dataset 475 may include the additional properties of “short_description” and “long_description”. Similarly, the enriched dialog dataset 480 may include the additional properties of “short_description” and “long_description”. The short_description may include a short description of, for example, an active dialog, wherein the short_description may be generated by LLM provider 102 based on the enriched dialog dataset 480. Similarly, the long_description may include a long description of, for example, an active dialog, wherein the long_description may be generated by LLM provider 102 based on the enriched dialog dataset 480. The textual description/data generated as the “long_description” may be lengthier and/or contain more data relative to the textual description/data generated as the “short_description.”

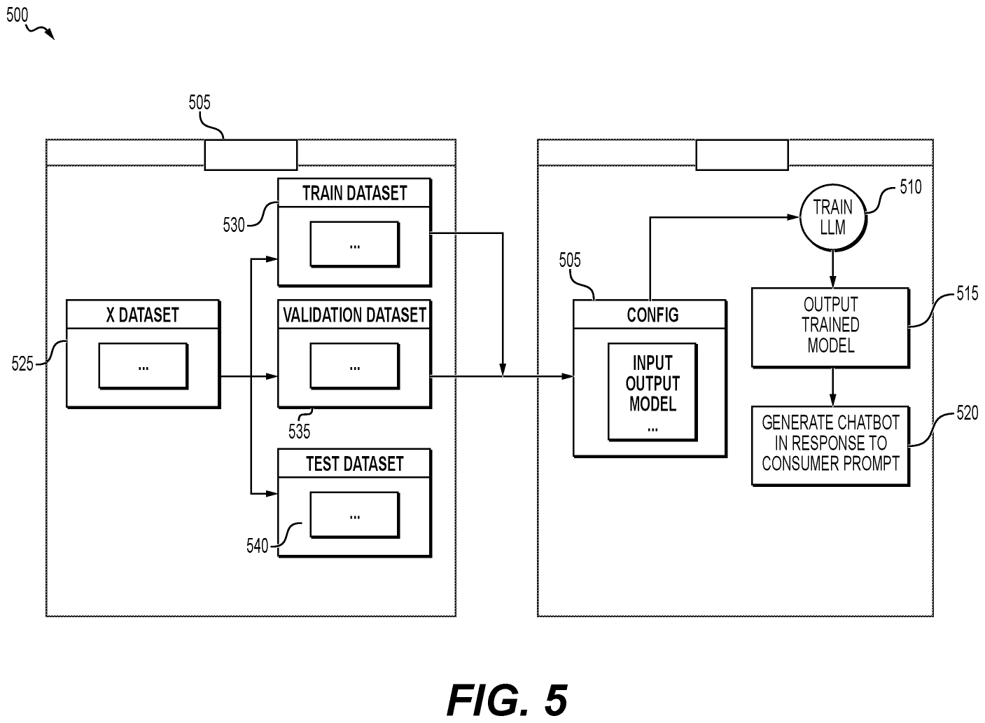

Referring now to FIG. 5, an exemplary flow diagram 500 is shown of a method of generating a trained machine learning model for generating chatbots, wherein the machine learning model is trained utilizing an enriched dataset and/or additional datasets, in accordance with an aspect. As shown in flow diagram 500 of FIG. 5, at step 505, an enriched dataset 525 is prepared for training a machine learning model. The enriched dataset 525 may be used to create a train dataset 530, a validation dataset 535, and/or a test dataset 540 to be utilized in training a machine learning model for generating chatbots. The enriched dataset 525 may be an enriched dataset generated in step 465 of the exemplary embodiment of FIG. 4.

At step 505, the enriched dataset 525 may be configured to a format necessary for the machine learning model. It will be appreciated by one of ordinary skill in the art that step 505 may vary or may be unnecessary where an enriched dataset 525 and/or a train dataset 530, validation dataset 535, and/or test dataset 540 has been previously configured/processed in a format suitable for the machine learning application.

At step 510, an LLM may be trained on the enriched dataset 525 and/or train dataset 530, validation dataset 535, and/or test dataset 540. For example, machine learning techniques may be utilized to train a model on historical or active chatbots and underlying data, including for example, interactions between an end-user and the chatbot, chat flows, elements, dialogs, topics, functions, etc. across various subjects of consumer chatbot engagement and interactions. A machine learning model may receive, as an input, an enriched dataset 525 and/or train dataset 530, validation dataset 535, and/or test dataset 540, wherein these data elements may be compared to, for example, historical bot data feeds to assess correlation of certain data objects (e.g., textual descriptions, dialog interactions between end-users and a bot, chat flows, elements, dialogs, topics, functions, etc.) As one non-limiting example, a trained dataset 530 may be used for training an LLM where the validation dataset 535 and/or test dataset 540 may be utilized for assessing certain threshold levels of confidence to determine whether predictions are accurate and are to be utilized in automated chatbot generation.

At step 515, the trained model may be output for real-time integration with a chatbot generation platform. At step 520, a chatbot generation may receive a prompt from a consumer with instructions for creating a chatbot (e.g., a chatbot dialog), or additionally/alternatively, the chatbot generation platform may receive a prompt from a consumer with instructions for revising an existing chatbot (e.g., a chatbot dialog).

A chatbot (e.g., chatbot dialog) is generated based on the trained dataset and based on the prompt from a consumer. For example, based on the prompt from the consumer, the chatbot may be generated in reference to the context and objectives contained in the prompt, wherein such context and objectives may be assessed considering the trained machine learning model. For example, machine learning techniques may be utilized to process the consumer prompt for dialog, intent, description, and/or other data to generate a chatbot correlating with historical data related to the processed dialog, intent, description, and/or other data to accurately and efficiently generate a chatbot in response to the consumer's prompt.

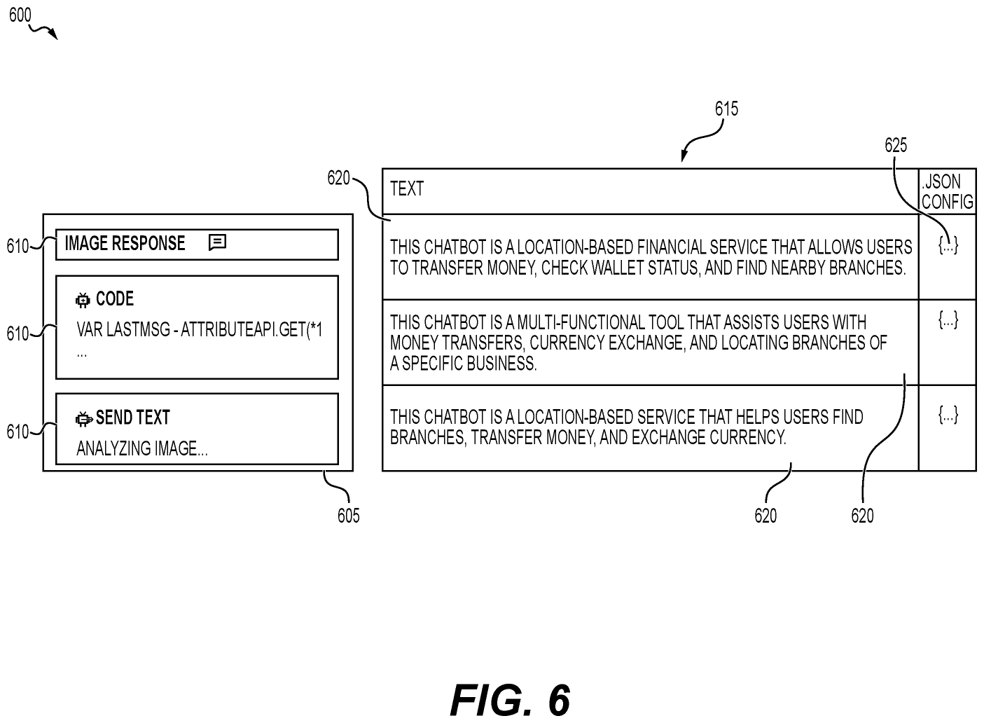

Referring to FIG. 6, an exemplary image 600 of an enriched dataset is illustrated in accordance with an aspect. As shown in exemplary image 600 of FIG. 6, a chatbot structure 605 (e.g., a .json config) is shown, including multiple chatbot dialog elements 610 that define interactions between an end-user and the chatbot structure 605.

The dataset(s) underlying the chatbot structure 605, including any historical data and/or additional chatbot structures, may be utilized to generate an enriched dataset including, for example, an enriched datafield 615 comprising individual descriptors 620 associated with a specific .json config 625, wherein the .json config 625 may correspond to a chatbot structure 605 and/or to individual chatbot dialog elements 610.

Individual descriptors 620 may describe, for example, a dialog dataset, including the functionality, context, usage, etc. of one or more chatbot structures 605 and/or individual chatbot dialog elements 610. These individual descriptors may then be integrated with an enriched dataset for purposes of training a machine learning model, as described elsewhere herein.

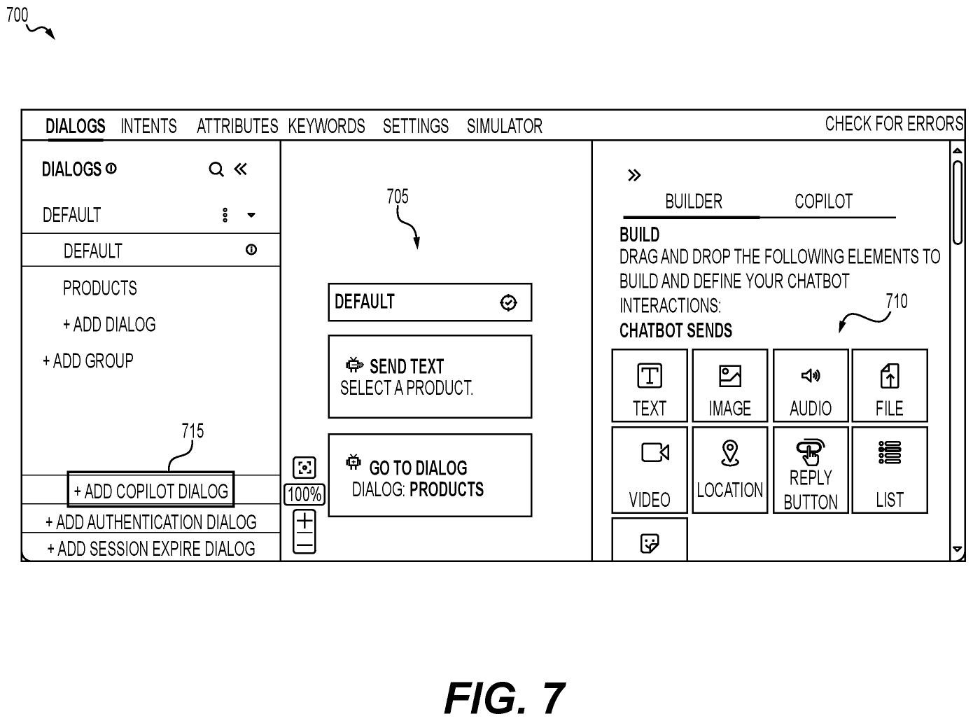

For example, and as shown in FIGS. 2, 4A-4B, an LLM provider (e.g., generative AI learning) may be utilized to create individual descriptors 620 (e.g., a synthetic dataset) that may be used to train a machine learning model, as depicted in FIGS. 3 and 5. The machine learning model may, in turn, be utilized to generate chatbot structures 605 such as those depicted in FIG. 6 and in FIGS. 7, 9, and 10.

Referring now to FIGS. 7-11, exemplary images of generating an automated chatbot utilizing a machine learning model are illustrated, in accordance with an aspect.

Referring now to FIG. 7, an exemplary image 700 of a chatbot generation interface is illustrated, in accordance with an aspect. A consumer may, for example, utilize visual-building elements 710 to create a chatbot dialog 705. Additionally or alternatively, a consumer may utilize a generative learning element 715 (e.g., a machine learning model) to create/revise a chatbot dialog 705, wherein the generative learning element 715 utilizes machine learning methods disclosed elsewhere herein to create/revise the chatbot dialog 705.

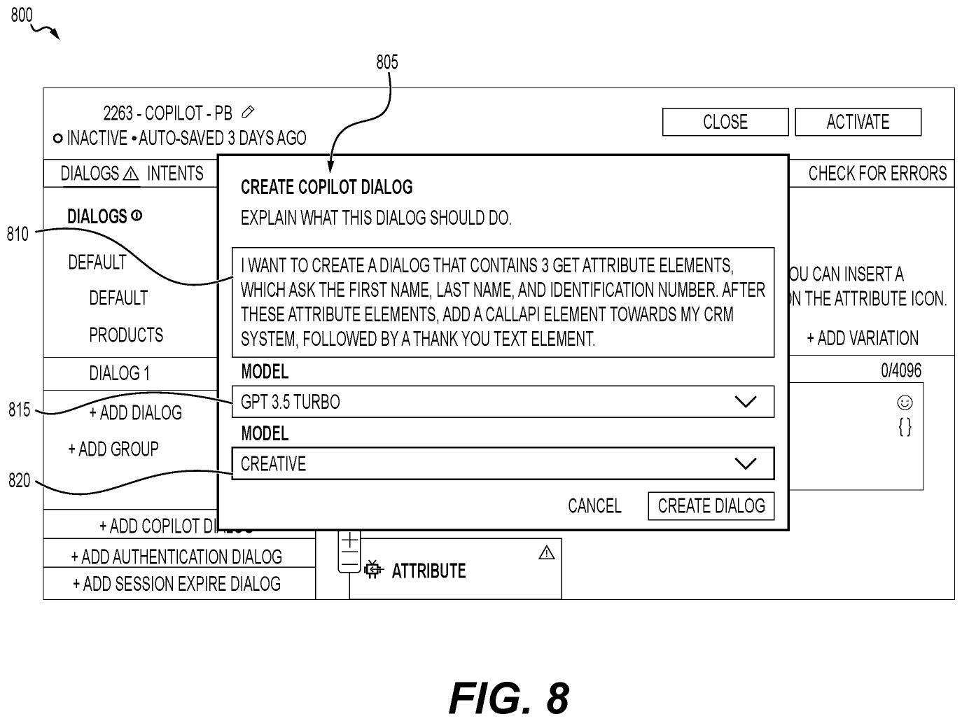

Referring now to FIG. 8, an exemplary image 800 of a prompt interface utilized in chatbot generation is illustrated, in accordance with an aspect. A consumer may utilize a prompt to provide a set of textual instructions for generating a chatbot or part of a chatbot.

As one non-limiting example, a consumer may utilize the prompt 805 to provide instructions 810 directed to designing a chatbot dialog 705 (as shown in FIG. 7) or an element of chatbot dialog 705. Similarly, a consumer may select one or more machine learning models 815 to be utilized, where such machine learning models 815 may include open source and/or proprietary models. The consumer additionally may select further customization modes 820. For example, under a Creative Mode, a variety of dialogs may be produced, where the machine learning model 815 may create different designs despite a consumer entering the same prompt to generate multiple dialogs. In contrast, for example, under a Conservative Mode, a consistent set of dialogs may be produced, where the machine learning model 815 may create the same design if a consumer enters the same prompt to generate multiple dialogs.

For example, the consumer may provide instructions for creating a dialog containing a certain number of “get attribute” elements, which ask the first name, last name, and identification of a user interacting with the chatbot. The prompt may further include instructions that after these attribute elements are obtained, an API element is added to a CRM system, followed by a “thank you” text element.

As an additional non-limiting example, a consumer may utilize the prompt to provide instructions directed to designing a dialog for a specific use case. For example, the consumer may provide instructions for creating a dialog to be used for an airline company, wherein the dialog can be used to check lost luggage status, report lost luggage, check flight terminals, book tickets, etc.

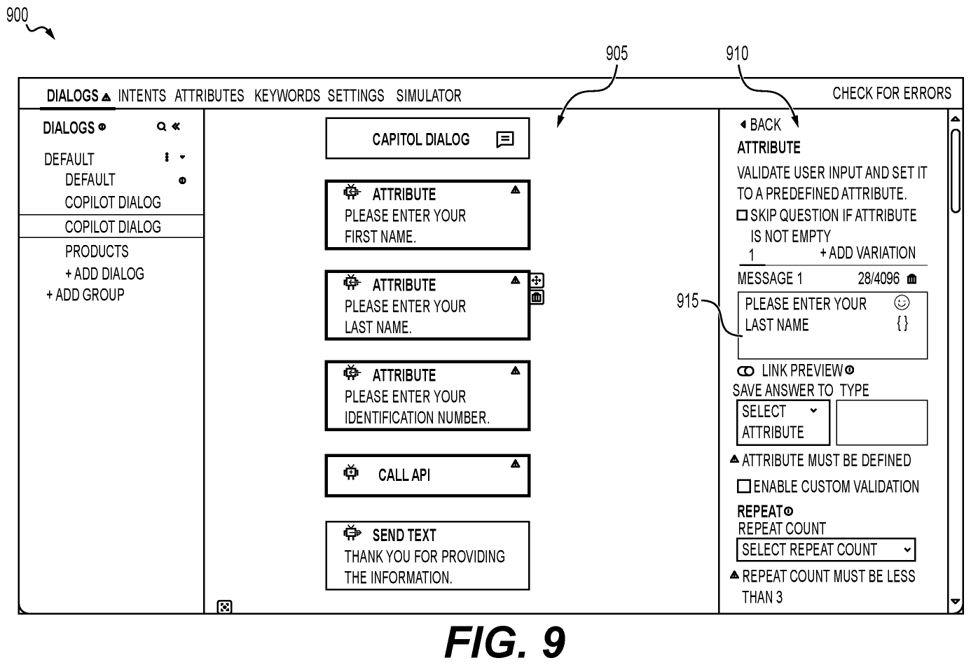

Referring now to FIG. 9, an exemplary image of a chatbot dialog interface 900 generated according to a machine learning model based upon prompt instructions from a consumer is illustrated, in accordance with an aspect.

According to one non-limiting example, a chatbot dialog 905 is generated in response to the prompt: “I want to create a dialog that contains 3 get attribute elements, which ask the first name, last name, and identification number. After these attribute elements, add an API element towards my CRM system, following by a thank you text element.” Attribute elements 910 (including text elements 915) contain relevant text and elements that are generated based on the prompt instructions.

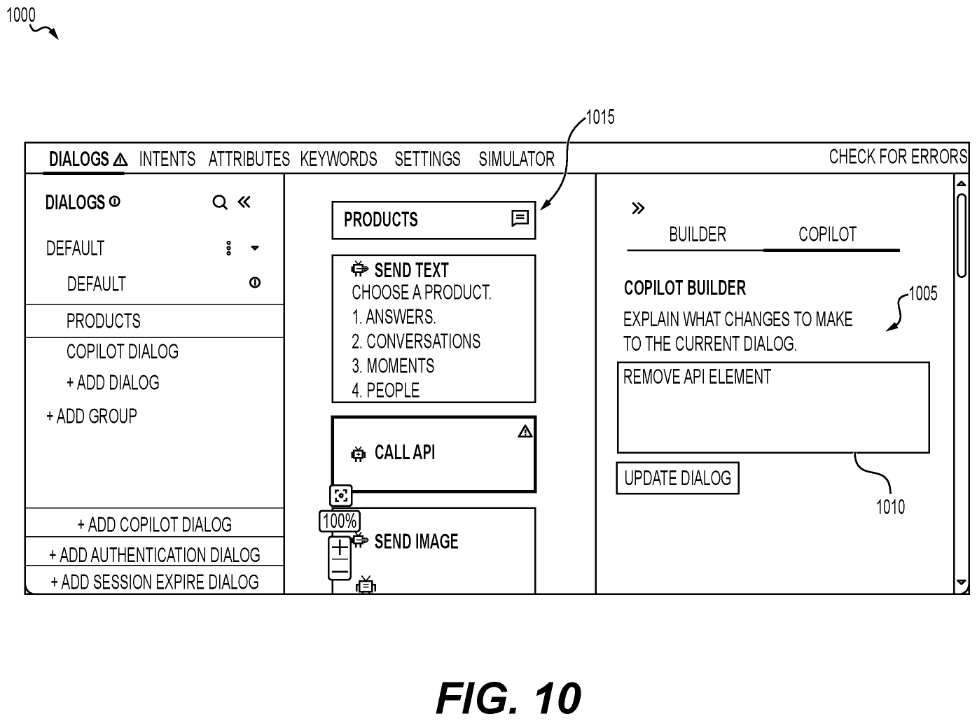

Referring now to FIG. 10, an exemplary image 1000 of a chatbot dialog editing/revising prompt interface utilized in chatbot generation is illustrated, in accordance with an aspect.

According to one non-limiting example, a consumer may utilize the editing prompt 1005 to provide instructions 1010 directed to editing/revising a chatbot dialog 705 or an element of chatbot dialog 1015. The consumer may, for example, provide textual instructions 1010 for editing/revising a chatbot or part of a chatbot.

According to one non-limiting example, a consumer may provide instructions 1010 in the editing prompt 1005 to “Remove API element”, whereupon an API element may be removed from the corresponding chatbot dialog 1015.

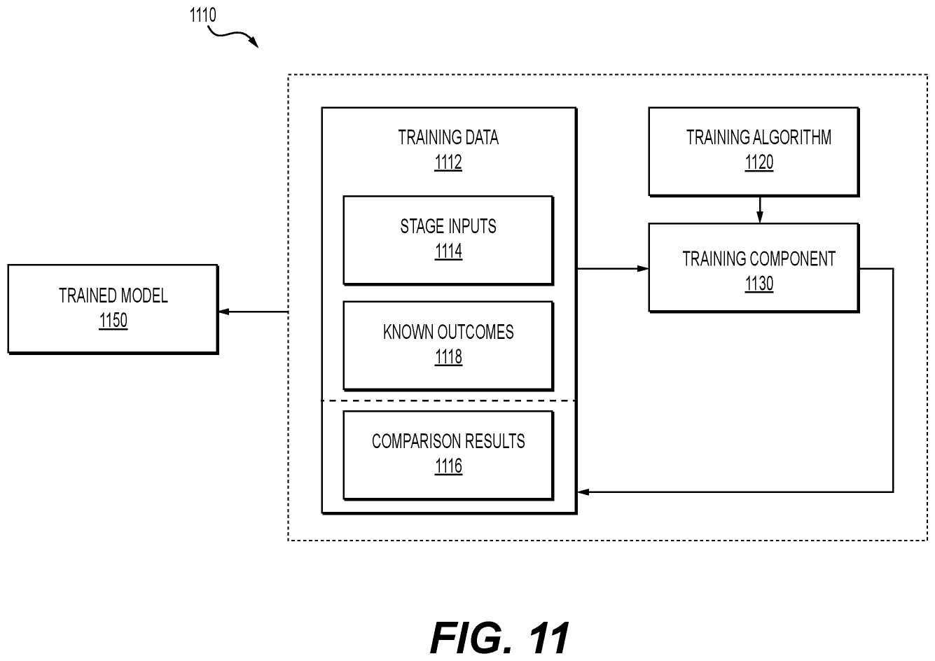

FIG. 11 depicts a flow diagram for training a machine learning model, in accordance with an aspect. As shown in flow diagram 1110 of FIG. 11, training data 1112 may include one or more of stage inputs 1114 and known outcomes 1118 related to a machine learning model to be trained. The stage inputs 1114 may be from any applicable source including a component or set shown in the figures provided herein. The known outcomes 1118 may be included for machine learning models generated based on supervised or semi-supervised training. An unsupervised machine learning model might not be trained using known outcomes 1118. Known outcomes 1118 may include known or desired outputs for future inputs similar to or in the same category as stage inputs 1114 that do not have corresponding known outputs.

The training data 1112 and a training algorithm 1120 may be provided to a training component 1130 that may apply the training data 1112 to the training algorithm 1120 to generate a trained machine learning model 1150. According to an implementation, the training component 1130 may be provided comparison results 1116 that compare a previous output of the corresponding machine learning model to apply the previous result to re-train the machine learning model. The comparison results 1116 may be used by the training component 1130 to update the corresponding machine learning model. The training algorithm 1120 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1110 may be a trained machine learning model 1150.

It will be appreciate that training of a machine learning model may incorporate, partially or wholly, elements of collection, cleaning, and processing an initial dataset and processing an enriched dataset, illustrated in FIGS. 2-5 discussed above. For example, training of a machine learning model may include training sets covering multiple bots, intents, dialogs, etc. of a historical and/or active nature, including training on identification of numerous datasets and data fields (e.g., intents, dialogs, structures, elements, content, attributes, channels, names, etc.)

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

FIG. 12 is a simplified functional block diagram of a computer 1200 that may be configured as a device for executing the methods disclosed here, according to exemplary aspects of the present disclosure. For example, the computer 1200 may be configured as a system according to exemplary aspects of this disclosure. In various aspects, any of the systems herein may be a computer 1200 including, for example, a data communication interface 1220 for packet data communication. The computer 1200 also may include a central processing unit (“CPU”) 1202, in the form of one or more processors, for executing program instructions. The computer 1200 may include an internal communication bus 1208, and a storage unit 1206 (such as ROM, HDD, SDD, etc.) that may store data on a computer readable medium 1222, although the computer 1200 may receive programming and data via network communications.

The computer 1200 may also have a memory 1204 (such as RAM) storing instructions 1224 for executing techniques presented herein, for example the methods described with respect to FIGS. 2-5, although the instructions 1224 may be stored temporarily or permanently within other modules of computer 1200 (e.g., processor 1202 and/or computer readable medium 1222). The computer 1200 also may include input and output ports 1212 and/or a display 1210 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating an automated chatbot training dataset, the method comprising:
collecting, via a computer, at least one initial chatbot dataset;
cleaning, via the computer, the at least one initial chatbot dataset;
generating, via the computer, at least one processed dataset, wherein the at least one processed dataset is based on the at least one cleaned initial chatbot dataset;
providing, via the computer, the at least one processed dataset to a large language model;
requesting, via the computer, a dataset property from the large language model, wherein the dataset property is based on a query submitted to the large language model;
receiving, via the computer, the dataset property from the large language model; and
generating, via the computer, at least one enriched dataset incorporating the dataset property.

2. The method of claim 1, wherein the initial chatbot dataset comprises one or more of a bot dataset, an intent dataset, or a dialog dataset.

3. The method of claim 1, wherein cleaning further comprises identifying data types in the initial chatbot dataset for removal or alteration.

4. The method of claim 1, wherein the large language model is a proprietary large language model.

5. The method of claim 1, wherein the at least one enriched dataset includes a textual description of the processed dataset output by the large language model.

6. The method of claim 5, wherein the textual description includes a short description and a long description.

7. The method of claim 1, further comprising training, via the computer, a machine learning model using the enriched dataset.

8. A system for generating an automated chatbot training dataset, the system comprising:
a non-transitory computer readable medium configured to store processor-readable instructions; and
a processor operatively connected to the non-transitory computer readable medium, and configured to execute the instructions to perform operations comprising:
collecting at least one initial chatbot dataset;
cleaning the at least one initial chatbot dataset;
generating at least one processed dataset, wherein the at least one processed dataset is based on the at least one cleaned initial chatbot dataset;
providing the at least one processed dataset to a large language model;
requesting a dataset property from the large language model, wherein the dataset property is based on a query submitted to the large language model;
receiving the dataset property from the large language model; and
generating at least one enriched dataset incorporating the dataset property.

9. The system of claim 8, wherein the initial chatbot dataset comprises one or more of a bot dataset, an intent dataset, or a dialog dataset.

10. The system of claim 8, wherein cleaning further comprises identifying data types in the initial chatbot dataset for removal or alteration.

11. The system of claim 8, wherein the large language model is a proprietary large language model.

12. The system of claim 8, wherein the at least one enriched dataset includes a textual description of the processed dataset output by the large language model.

13. The system of claim 12, wherein the textual description includes a short description and a long description.

14. The system of claim 8, wherein the operations further comprise training a machine learning model using the enriched dataset.

15. A non-transitory computer readable medium configured to store processor-readable instructions, wherein when executed by a processor, the instructions perform operations comprising:
collecting at least one initial chatbot dataset;
cleaning the at least one initial chatbot dataset;
generating at least one processed dataset, wherein the at least one processed dataset is based on the at least one cleaned initial chatbot dataset;
providing the at least one processed dataset to a large language model;
requesting a dataset property from the large language model, wherein the dataset property is based on a query submitted to the large language model;
receiving the dataset property from the large language model; and
generating at least one enriched dataset incorporating the dataset property.

16. The non-transitory computer readable medium of claim 15, wherein the initial chatbot dataset comprises one or more of a bot dataset, an intent dataset, or a dialog dataset.

17. The non-transitory computer readable medium of claim 15, wherein cleaning further comprises identifying data types in the initial chatbot dataset for removal or alteration.

18. The non-transitory computer readable medium of claim 15, wherein the large language model is a proprietary large language model.

19. The non-transitory computer readable medium of claim 15, wherein the at least one enriched dataset includes a textual description of the processed dataset output by the large language model.

20. The non-transitory computer readable medium of claim 15, further comprising training a machine learning model using the enriched dataset.
